(19) United States
(12) Patent Application Publication
(10) Pub. No.: US 2004/0128419 A1
(43) Pub. Date: Jul. 1, 2004

(54) Direct-coupled serial transmission interface card

(76) Inventor: Huang Chien-Chung, Taipei Hsien (TW)

Correspondence Address: Michael D. Bednarek, SHAWPITTMAN, 1650 Tysons Boulevard, McLean, VA, 22102-4859, US

(21) Appl. No.: 10/652,303

(22) Filed: Sep. 2, 2003

(30) Foreign Application Priority Data
Dec. 13, 2002 (TW) 091136162

(51) Int. Cl. G06F 13/00

(52) U.S. Cl. 710/300

(57) ABSTRACT

A direct-coupled serial transmission interface card for use in an electronic device having an interface card slot includes a circuit board and a serial port. The circuit board is removably positioned within the interface card slot, and the serial port is formed on the circuit board. When the circuit board is received within the interface card slot, the serial port is correspondingly engaged with the contacts mounted in the interface card slot.

### FIELD OF THE INVENTION

The present invention is related to a serial transmission interface card, and more particularly, to a direct-coupled serial transmission interface card.

### BACKGROUND OF THE INVENTION

For a conventional portable peripheral device, it is necessary to be coupled to a host by a serial transmission interface enabling data reader or a serial transmission cable. Namely, if a conventional portable peripheral device is desired to be coupled to a host by a serial transmission interface, an electric cable or a data reading device is indispensable for the serial connection between the portable peripheral device and the host. Nonetheless, such a configuration is not quite facilitating, and the total size of the portable peripheral device can not be reduced any further.

The present invention particularly endeavors to contrive a serial transmission interface card which enables a portable peripheral device to be directly coupled to a host so as to downsize the portable peripheral device.

### SUMMARY OF THE INVENTION

To attain the aforementioned objects, the present invention addresses a direct-coupled serial transmission interface card that can fulfill a reliable serial data transmission between a portable peripheral device and a host, while miniaturize the portable peripheral device.

In accordance with the present invention, a direct-coupled serial transmission interface card is disclosed and adapted for use in an electronic device having an interface card slot with a plurality of first contacts mounted therein. The direct-coupled serial transmission interface card in accordance with the present invention includes a circuit board and a plurality of second contacts. The circuit board is removably positioned within the interface card slot, and the second contacts are formed on the circuit board. When the circuit board is placed within the interface card slot, each of the second contact is respectively engaged with a corresponding one of the first contacts.

In a preferred embodiment, the direct-coupled serial transmission interface card further includes a casing surrounding the circuit board with the second contacts being exposed to the exterior of the casing.

In a preferred embodiment, the direct-coupled serial transmission interface card further includes a controller mounted on the circuit board and electrically connected with the second contacts for processing commands and data transmitted between the electronic device and the direct-coupled serial transmission interface card.

The direct-coupled serial transmission interface card may further include a flash memory mounted on the circuit board and electrically connected with the controller for enabling the direct-coupled serial transmission interface card to serve as a data storage device.

Alternatively, the direct-coupled serial transmission interface card may further include a digital still camera module mounted on the circuit board and electrically connected with the controller for enabling the direct-coupled serial transmission interface card to serve as a digital image processing device.

Alternatively, the direct-coupled serial transmission interface card may further include a bluetooth module mounted on the circuit board and electrically connected with the controller for enabling the direct-coupled serial transmission interface card to serve as a bluetooth enabling radio frequency communication device.

Alternatively, the direct-coupled serial transmission interface card may further include a wireless communication module mounted on the circuit board and electrically connected with the controller for enabling the direct-coupled serial transmission interface card to serve as a wireless signal transceiver.

Alternatively, the direct-coupled serial data transmission interface card may further include a global positioning system (GPS) module mounted on the circuit board and electrically connected with the controller for enabling the direct-coupled serial transmission interface card to serve as a global positioning system signal transceiver.

Alternatively, the direct-coupled serial transmission interface card may further include a data packet transmission module mounted on the circuit board and electrically connected with the controller for enabling the direct-coupled serial transmission interface card to serve as a data packet transmission device.

Alternatively, the direct-coupled serial transmission interface card may further include a local area network module mounted on the circuit board and electrically connected with the controller for enabling the direct-coupled serial transmission interface card to serve as a local area network interface card.

The other objects, features and advantages of the present invention will become more apparent through the following descriptions with reference to the accompanying drawings, wherein:

### BRIEF DESCRIPTION OF THE DRAWINGS

FIG. 1a is an exploded view showing the formation of a direct-coupled serial transmission interface card in accordance with a preferred embodiment of the present invention;

FIGS. 1b and 1c are plan views showing an assembled direct-coupled serial transmission interface card in accordance with a preferred embodiment of the present invention;

FIG. 1d is a schematic diagram showing a direct-coupled serial transmission interface card of FIG. 1a viewed from a different aspect;

FIG. 2 is a systematic representation of a direct-coupled serial transmission interface card in accordance with a preferred embodiment of the present invention; and

FIG. 3 is a schematic diagram showing a direct-coupled serial transmission interface card to be placed in an electronic device in accordance with a preferred embodiment of the present invention;

### DETAILED DESCRIPTION OF THE PREFERRED EMBODIMENT

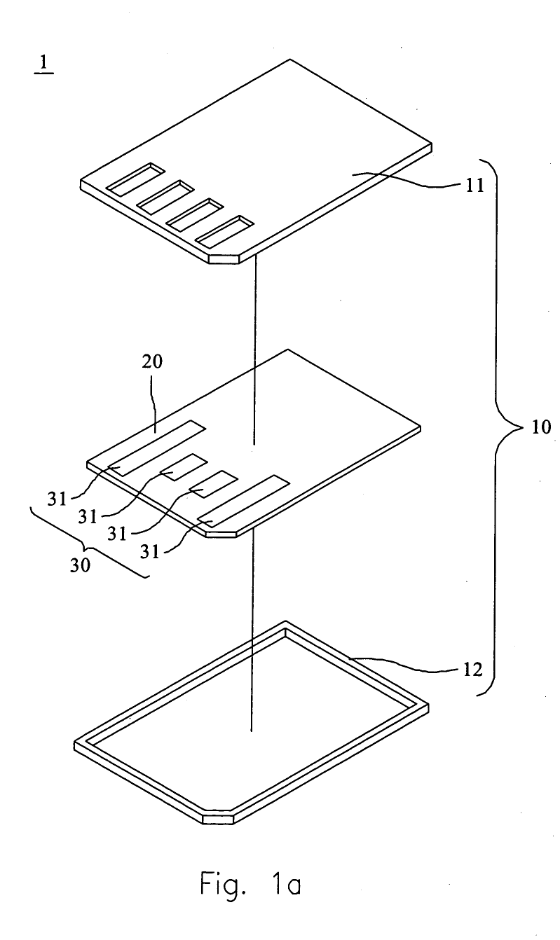

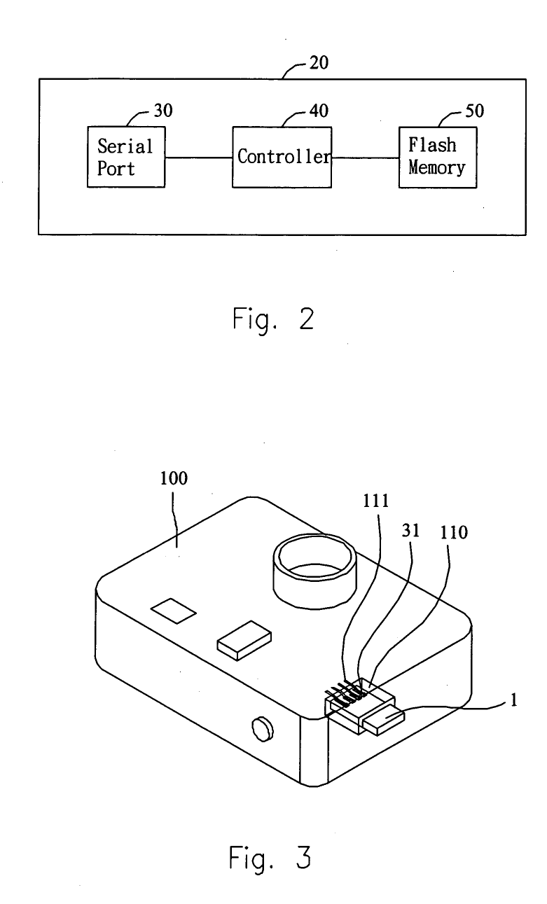

FIGS. 1a, 1b and 1c demonstrate a preferred embodiment of a direct-coupled serial transmission interface card 1 in accordance with the present invention that is adapted for use in the electronic device 100 of FIG. 3 having an interface card slot 110 with a plurality of first contacts 111 mounted therein. It should be noted that the interface card slot 110 is an inherent built-in component in the electronic device 100, so that it is unnecessary to incorporate an additional interface card slot into the electronic device 100. Further, the electronic device 100 of FIG. 3 is illustratively embodied in a digital still camera as an example, but the form of the electronic device 100 is not to be restrictedly limited to this; it may includes a personal digital assistance (PDA), a video capturing device, an information appliance and so on. In addition, the interface card slot 110 shown in FIG. 3 is shown in a form of a USB connector slot, and thus it embraces four first contacts 111 inside. However, the form of the interface card slot 110 is not to be exhaustively restricted to a USB connector slot, on the other hand, it may be directed to an RS-232 connection port or an IEEE-1394 interface connector.

The direct-coupled serial transmission interface card 1 in accordance with a preferred embodiment of the present invention includes a casing 10, a circuit board 20, a serial port 30, a controller 40, and a flash memory 50. The casing 10 is made up of a top cover and a bottom plate both of which surround the circuit board 20 in a manner of exposing the serial port 30 to the exterior of the casing 10.

The circuit board 20 is encased in the casing 10 and removably positioned within the interface card slot 110 of the electronic device 100 of FIG. 3. The serial port 30 is formed on a top surface of the circuit board 20 and includes a plurality of second contacts 31 to be electrically engaged with the interface card slot 110 of the electronic device 100 of FIG. 3. It is to be noted that the number of the second contacts 31 as shown in FIG. 1a is four in order that the each of the second contacts 31 is electrically engaged with a corresponding one of the four first contacts 111. However, it can be readily understood by one skilled in the art that the number of the second contacts 21 is unnecessary to be limited at four, but is prescribed depending on the serial transmission specification used by the direct-coupled serial transmission interface card 1.

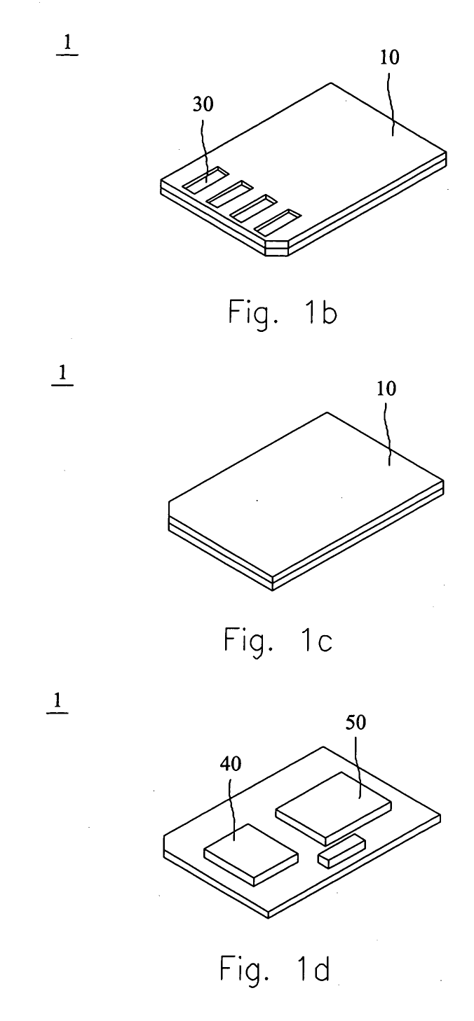

The controller 40 is mounted on a surface of the circuit board 20. As shown in FIG. 1d, the controller 40 is arranged on an opposite surface to the surface of serial port 30. However, the actual arrangement of the controller 40 is unnecessary to be exactly the same manner as above, that is, the controller 40 may be arranged in co-plane with the serial port 30. More specifically, the controller 40 is used to process the commands and data transmitted between the electronic device 100 and the direct-coupled serial transmission interface card 1. Referring to FIG. 2, the controller 40 is electrically connected with the second contacts 31, and coupled to the interface card slot 110 through the serial ports, in order that the electronic device 100 can identify the presence of the direct-coupled serial transmission interface card 1.

The flash memory 50 is mounted on a surface of the circuit board 20. As shown in FIG. 1d, the flash memory 50 is arranged in co-plane with the controller 40, however, the actual arrangement of the flash memory is unnecessary to be exactly the same manner as described above. Referring to FIG. 2, the flash memory 50 is electrically connected with the controller 40 for allowing the direct-coupled serial transmission interface card 1 to serve as a data storage device.

It is to be understood that if the direct-coupled serial transmission interface card 1 is provided with a flash memory 50 therein, it may serve as a data storage device. Namely, when the direct-coupled serial transmission interface card 1 is inserted into the electronic device 100, the direct-coupled serial transmission interface card 1 is sufficient to provide a data storage capability for the electronic device.

Remarkably, the direct-coupled serial transmission interface card 1 in accordance with the present invention is versatile. For example, the flash memory 50 can be replaced with a digital still camera module (not shown) so that the direct-coupled serial transmission interface card 1 can serve as a digital image processing device. That is to say, when the direct-coupled serial transmission interface card 1 is inserted into the electronic device 100, it can provide the electronic device 100 with a desired function of digital image processing.

Alternatively, the flash memory 50 can be replaced with a bluebooth module (not shown) so that the direct-coupled serial transmission interface card 1 can serve as a bluebooth enabling radio frequency (RF) communication device. That is to say, when the direct-coupled serial transmission interface card 1 is inserted into the electronic device 100, it can provide the electronic device 100 with a desired function of bluetooth communication.

Alternatively, the flash memory 50 can be replaced with a wireless communication module (not shown) so that the direct-coupled serial transmission interface card 1 can serve as a wireless signal transceiver. That is to say, when the direct-coupled serial transmission interface card 1 is inserted into the electronic device 100, it can provide the electronic device 100 with a desired function of wireless communication.

Alternatively, the flash memory 50 can be replaced with a global positioning system (GPS, which is not shown in the drawings) module so that the direct-coupled serial transmission interface card 1 can serve as a GPS signal transceiver. That is to say, when the direct-coupled serial transmission interface card 1 is inserted into the electronic device 100, it can provide the electronic device 100 with a desired function of transmitting/receiving GPS signal.

Alternatively, the flash memory 50 can be replaced with a data packet transmission module (not shown) so that the direct-coupled serial transmission interface card 1 can serve as a data packet transmission device. That is to say, when the direct-coupled serial transmission interface card 1 is inserted into the electronic device 100, it can provide the electronic device 100 with a desired function of data packet transmission.

Alternatively, the flash memory 50 can be replaced with a local area network module (LAN, which is not shown in the drawings) so that the direct-coupled serial transmission interface card 1 can serve as a LAN communication device. That is to say, when the direct-coupled serial transmission interface card 1 is inserted into the electronic device 100, it can provide the electronic device 100 with a desired function of local area network transmission.

In addition, it can be easily understood that two or more function modules can be implanted into the a single direct-coupled serial transmission interface card 1 of the present invention. For example, a flash memory and a digital still camera module can coexist in a single direct-coupled serial transmission interface card 1 of the present invention so that the direct-coupled serial transmission interface card of the present invention can provide two or more functions as desired.

As discussed in the foregoing, the direct-coupled serial transmission interface card of the present invention can be applied to an existing interface card slot of an electronic device straightforwardly, and it is unnecessary to add an extra interface card slot to co-operate with a serial transmission device. In view thereof, the direct-coupled serial transmission interface card of the present invention is not only convenient for use but eliminate the requisition of redesigning the whole electronic device.

It is a more profitable benefit of the present invention that the function modules to be implanted into the direct-coupled serial transmission interface card can be arbitrarily arranged so as to produce a direct-coupled serial transmission interface card with a greater versatility.

Although the present invention has been described and illustrated in detail, it is to be clearly understood that the same is by the way of illustration and example only and is not to be taken by way of limitation, the spirit and scope of the present invention being limited only by the terms of the appended claims.

What is claimed is:

1. A direct-coupled serial transmission interface card for use in an electronic device having an interface card slot with a plurality of first contacts mounted therein, the direct-coupled serial data transmission card comprising:
a circuit board removably positioned within the interface card slot; and
a plurality of second contacts formed on the circuit board, each of the plurality of second contacts establishes an electric connection with a corresponding one of the plurality of first contacts when the circuit board is received in the interface card slot.

2. The direct-coupled serial transmission interface card of claim 1 further comprising a casing surrounding the circuit board and exposing the plurality of second contacts.

3. The direct-coupled serial transmission interface card of claim 1 further comprising a controller mounted on the circuit board and electrically connected with the plurality of second contacts for processing commands and data transmitted between the electronic device and the direct-coupled serial transmission interface card.

4. The direct-coupled serial transmission interface card of claim 3 further comprising:
a flash memory mounted on the circuit board and electrically connected with the controller for enabling the direct-coupled serial transmission interface card to serve as a data storage device.

5. The direct-coupled serial transmission interface card of claim 3 further comprising:
a digital still camera module mounted on the circuit board and electrically connected with the controller for enabling the direct-coupled serial transmission interface card to serve as a digital image processing device.

6. The direct-coupled serial transmission interface card of claim 3 further comprising:
a bluetooth module mounted on the circuit board and electrically connected with the controller for enabling the direct-coupled serial transmission interface card to serve as a bluetooth enabling radio frequency communication device.

7. The direct-coupled serial transmission interface card of claim 3 further comprising:
a wireless communication module mounted on the circuit board and electrically connected with the controller for enabling the direct-coupled serial transmission interface card to serve as a wireless signal transceiver.

8. The direct-coupled serial transmission interface card of claim 3 further comprising:
a global positioning system module mounted on the circuit board and electrically connected with the controller for enabling the direct-coupled serial transmission interface card to serve as a global positioning system signal transceiver.

9. The direct-coupled serial transmission interface card of claim 3 further comprising:
a data packet transmission module mounted on the circuit board and electrically connected with the controller for enabling the direct-coupled serial transmission interface card to serve as a data packet transmission device.

10. The direct-coupled serial transmission interface card of claim 3 further comprising:
a local area network module mounted on the circuit board and electrically connected with the controller for enabling the direct-coupled serial transmission interface card to serve as a local area network interface card.

11. A direct-coupled serial transmission interface card for use in an electronic device having an interface card slot with a plurality of first contacts mounted therein, the direct-coupled serial data transmission card comprising:
a circuit board removably positioned within the interface card slot; and
a serial port formed on the circuit board and electrically engaged with the interface card slot when the circuit board is received in the interface card slot.

12. The direct-coupled serial transmission interface card of claim 11 further comprising:
a casing surrounding the circuit board and exposing the serial port to an exterior of the casing.

13. The direct-coupled serial transmission interface card of claim 12 further comprising:
a controller mounted on the circuit board and electrically connected with the serial port for processing commands and data transmitted between the electronic device and the direct-coupled serial transmission interface card.

14. The direct-coupled serial transmission interface card of claim 13 further comprising a flash memory mounted on the circuit board and electrically connected with the controller for enabling the direct-coupled serial transmission interface card to serve as a data storage device.

15. The direct-coupled serial transmission interface card of claim 13 further comprising a digital still camera module mounted on the circuit board and electrically connected with the controller for enabling the direct-coupled serial transmission interface card to serve as a digital image processing device.

16. The direct-coupled serial transmission interface card of claim 13 further comprising a bluetooth module mounted on the circuit board and electrically connected with the controller for enabling the direct-coupled serial transmission interface card to serve as a bluetooth enabling radio frequency communication device.

17. The direct-coupled serial transmission interface card of claim 13 further comprising a wireless communication module mounted on the circuit board and electrically connected with the controller for enabling the direct-coupled serial transmission interface card to serve as a wireless signal transceiver.

18. The direct-coupled serial transmission interface card of claim 13 further comprising a global positioning system module mounted on the circuit board and electrically connected with the controller for enabling the direct-coupled serial transmission interface card to serve as global positioning system signal transceiver.

19. The direct-coupled serial transmission interface card of claim 13 further comprising a data packet transmission module mounted on the circuit board and electrically connected with the controller for enabling the direct-coupled serial transmission interface card to serve as a data packet transmission device.

20. The direct-coupled serial transmission interface card of claim 13 further comprising a local area network module mounted on the circuit board and electrically connected with the controller for enabling the direct-coupled serial transmission interface card to serve as a local area network communication device.
